(19) United States
(12) Patent Application Publication
(10) Pub. No.: US 2007/0275245 A1
(43) Pub. Date: Nov. 29, 2007

(54) Activation Of A Glass Surface

(76) Inventors: Ronnie Persson, Malmo (SE); Bertrand Lerebourg, Angelholm (FR); Pavel Studeny, Limhamn (SE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/587,762

(22) PCT Filed: Apr. 27, 2005
(86) PCT No.: PCT/FR05/50281

§ 371 Date: Jan. 22, 2007

(30) Foreign Application Priority Data
Apr. 28, 2004 (FR) 0404531

(51) Int. Cl. C03C 19/00; B05D 3/00

(52) U.S. Cl. 428/410; 427/299; 296/84.1; 65/60.1; 65/61

(57) ABSTRACT

The invention relates to a pane of curved glass, at least one of the main faces of which is activated. The activation may especially be performed by abrasion by direct rubbing of the glass surface. Advantageously, an abrasive belt closed on itself and traveling over the surface of the glass is used. After activation, a hydrophobic coat may be deposited using, for example, a fluorinated silane. The glass coated with a hydrophobic coat may be used as window glass for a motor vehicle.

The invention relates to a process for activating the surface of glass to make it more receptive to subsequent treatments, generally for the deposition of coats, for instance a hydrophobic coat.

Hydrophobic properties are desired for glazing and windshields in the transportation field, in particular for motor vehicles and aircraft, and also for glazing in the construction field. For applications in the transportation field, rain-repelling properties are desired, the drops of water on windshields thus needing to run easily along the glass wall in order to be removed, for example under the effect of the air and wind when the vehicle is running, with the aim of improving the visibility and, consequently, the safety, or to facilitate the cleaning, to remove frost easily, etc. It is estimated that the surface of a substrate is hydrophobic if the angle of contact of a drop of water with the substrate is greater than 60° or 70°, without the drop of water becoming crushed or spread. Specifically, glazing is said to be functional as long as this angle is greater than 60° for aviation and 70° for motor vehicles. However, it is appropriate in practice to exceed in all cases a value of 90°, the ideal being to obtain running of the drops that allows the water to be removed so quickly that the windshield wipers can be dispensed with as much as possible in the motor vehicle field. Moreover, the improvement of the hydrophobic properties that is thus sought should not take place to the detriment of the conservation of the other properties, such as the resistance to mechanical constraints: tangential friction resistance (Opel test, standardized under dry conditions), the abrasion resistance (Taber), the resistance to wiping with windshield wipers (test simulating the sweep cycles of a windshield wiper); the resistance to environmental constraints (WOM test of resistance to UVA or Xenon test; QUV test of resistance to UVB for aircraft; BSN test of resistance to neutral saline fog); the resistance to chemical constraints: test of resistance to acidic and basic detergents; and the optical properties.

The Applicant has observed that coats of diverse nature (including hydrophobic coats) held less well when the surface of a glass substrate showed a certain degree of ageing in ambient air. Such ageing undoubtedly arises from the change in the chemical state of the surface. The coats deposited on an aged surface present overall less adhesion, and less uniform adhesion. It is estimated that a surface is substantially aged once it has spent at least one hour in ambient air below 100° C. Thus, any glass object that has been normally stored in order to be taken later to apply a deposit has a surface that is aged within the meaning of the invention. This type of aged surface may especially be the surface of curved glazing, especially for motor vehicles, for example motor vehicle side window glass. It is noted that the surface of a glass coming directly from a flat glass forming plant naturally has an activated and thus non-aged surface. If it is not left for too long, a coat may thus be deposited directly onto such a surface without it being necessary to perform an activation treatment.

The activation process according to the invention is applied directly to the surface of the glass without it being necessary either to heat or to apply a particular undercoat in order to regenerate the surface. According to the invention, the surface is regenerated (or “activated” or “buffed”) by abrasion, i.e. removal of material, even if this abrasion may be so light that its effects are not visible to the naked eye or even, where appropriate, to a scanning electron microscope. Thus, this abrasion may even be of the order of an atomic monocoat. This abrasion is thus applied directly to the glass surface not containing any coats (a coat may optionally be present on the face that is not to be activated). This treatment is applied to the entire surface, i.e. especially to the periphery and the central area. The use of any chemical product that attacks glass, for instance an acid, is not necessary to activate the surface, neither before, nor during, nor after the present abrasion treatment, even before the application of any surface coat or undercoat.

This abrasion may especially be performed by treating the surface with a plasma or an ionized gas at reduced or atmospheric pressure, chosen from air, oxygen, nitrogen, argon, hydrogen, helium and ammonia, or a mixture of these gases, or an ion beam.

This abrasion may also be performed by rubbing the surface with a polishing abrasive. The abrasive comprises abrasive grains. The term “polishing” is slightly incorrect in the present context since the abrasive will make the surface slightly coarse, such that, in general, the surface is slightly coarser after polishing than before. Nevertheless, it is “polishing” abrasives that may be used. The abrasive material may especially be very fine cerium oxide (particle size: for example 0.1 to 5 μm). Preferably, the grains of abrasive are fine enough not to create scratches that are visible to the naked eye. Preferably, the abrasion does not produce any scratches that are visible to the naked eye.

The polishing treatment may be performed manually. In this case, an operator passes an orbital sander fitted with a pad of the Scotchbrite type or a cotton pad over the surface, which has also received a dispersion comprising a liquid, generally an aqueous liquid, and an abrasive powder, for instance a cerium oxide powder. The dispersion may contain, for example, 5% to 30% by weight of cerium oxide. The surface is then rinsed with water. A composite abrasive at the same time comprising a support acting as matrix for the abrasive grain held on the surface of the support may also be used. In this case, during the polishing operation, it suffices to add water to the surface to be treated. The composite abrasive may also be applied to the orbital sander by an operator. After rinsing, the glass is dried.

The polishing treatment may also be performed automatically. To do this, a composite abrasive described above may preferably be used. This abrasive may have the form, for example, of a disk and may be driven in a rotational motion during the polishing action. A belt, generally closed on itself, may also be used as abrasive.

The machine fitted with the polishing belt may be one of those usually used for flashing or deburring metal components.

The glass may be handled by a robot. The robot grips the glass by means of suction pads applied to the main face (which is generally concave) opposite the face to be treated. Water is continuously sprayed onto the surface and the polishing belt during the treatment so as to gradually remove the cerium oxide and also the polishing debris. The robot applies half of the glass against the traveling belt, and optionally rotates it by 180° to again apply it to the other half. The pressure of the belt on the glass is controlled at all times by compliance means so as to ensure homogeneous buffing.

The activation treatments that have just been described activate the surface so much that the coats deposited thereafter adhere better and more homogeneously to the glass. This activation of the surface of the glass is reflected by a strong hydrophilic nature. This hydrophilic nature is witnessed by observing whether sprayed water spreads out well and homogeneously on the surface, or by means of surface tension measurements, for example using calibration liquids of the Plasmatreat® type. The activation treatment according to the invention leads to an activated and hydrophilic surface with a surface tension of at least 62 mN/m at any point.

After activation according to the invention, the activated surface may especially be coated with a hydrophobic coat. Generally, the hydrophobic coat itself is preceded by a mineral undercoat comprising silicon coordinated to at least one other chemical element such as O, and/or C, and/or N, said undercoat serving as primer for the grafting of the molecules of hydrophobic nature, generally fluorinated silane molecules.

The undercoat containing Si may especially consist of a compound chosen from SiOₓ with x less than or equal to 2, SiOC, SiON, SiOCN and Si₃N₄, hydrogen possibly being combined in any proportion with SiOₓ with x less than or equal to 2, SiOC, SiON and SiOCN. It may contain aluminum, in particular up to 8% by weight, or alternatively carbon, Ti, Zr, Zn or B. Mention may also be made of undercoats consisting of scratchproof varnish, such as polysiloxanes, which have been applied as a coat to polycarbonate substrates. The undercoat containing Si has a thickness especially of between 1 nm and 250 nm and especially between 2 nm and 100 nm. The coat containing silicon can be deposited onto the substrate, without heating, by cathodic sputtering, under vacuum, preferably assisted by a magnetic field and/or an ion beam, or by PECVD at low pressure or at atmospheric pressure, or alternatively under hot conditions by pyrolysis.

This coat of silica may also be produced by applying a solution of an alkoxysilane, for instance tetraethyl orthosilicate (or tetraethoxysilane) of formula Si(OCH₂CH₃)₄, commonly known as TEOS. A solution of TEOS in isopropanol may especially be applied. This operation may be performed at room temperature by manual wiping by an operator.

After application of the undercoat, the hydrophobic coat should be applied without delay. The reason for this is that, if there is too much of a delay, the surface of the undercoat tends to become deactivated (in the same way as the glass substrate before the activation according to the invention), and the surface of the undercoat would thus have to be reactivated. In practice, it is recommended to apply the hydrophobic coat as quickly as possible after applying the undercoat. For the case of an application of TEOS dissolved in isopropanol, the evaporation of the solvent and the reaction of the TEOS are quick enough for it not to be necessary to perform a particular drying treatment before applying the hydrophobic coat.

The hydrophobic coat may also be applied by manual wiping by an operator.

To make the hydrophobic coat, it is possible to apply a compound chosen from:

(a) the alkylsilanes of formula (I):
CH₃(CH₂)ₙSiRₘX₃₋ₘ (I)
in which:
n is from 0 to 30 and more particularly from 0 to 18;
m=0, 1, 2 or 3;
R represents an optionally functionalized organic chain;
X represents a hydrolyzable residue such as a residue OR⁰, with R⁰ representing hydrogen or a linear, branched or cyclic, especially C₁-C₈ alkyl residue; or an aryl residue, or such as a halo residue, for example chloro;
   (b) compounds containing grafted siloxane chains, for instance (CH₃)₃SiO[Si(CH₃)₂O]₂, without particular limitation as regards the chain length (value of q) and the method of grafting;
   (c) fluorinated silanes, for example the fluorinated silanes of formula (II):
   R¹—A—SiR²ₚX₃₋ₚ
   in which
R¹ represents a mono-, oligo- or perfluoro alkyl residue, especially of C₁-C₉; or a mono-, oligo- or perfluoro aryl residue;
A represents a hydrocarbon-based chain, optionally interrupted with a hetero atom such as O or S;
R² represents a linear, branched or cyclic, especially C₁-C₈ alkyl residue, or an aryl residue;
X represents a hydrolyzable residue such as a residue OR³, with R³ representing hydrogen or a linear, branched or cyclic, especially C₁-C₈ alkyl residue, or an aryl residue, or such as a halo residue, for example chloro; and
p=0, 1 or 2.

An example of an alkylsilane of formula (I) is octadecyltrichlorosilane (OTS). The preferred hydrophobic agents are fluorinated silanes (c), in particular those of formula (II), particular examples of the latter being those of formula:
CF₃—(CF₂)ₙ—(CH₂)₂—Si(OR⁴)₃
in which:
R⁴ represents an alkyl residue; and
n is between 7 and 11.

It may especially be CF₃ (CF₂)₇CH₂CH₂Si(OCH₂CH₃)₃.

The hydrophobic agent may generally be applied manually by wiping, i.e. using a cloth impregnated with this agent.

The hydrophobic coat especially has a thickness of between 1 and 100 nm and preferably between 2 and 50 nm. The fluorinated hydrophobic coat may have a mass thickness of grafted fluorine of between 0.1 μg/cm² and 3.5 μg/cm² and in particular between 0.2 μg/cm² and 3 μg/cm².

The Opel test for characterizing the resistance of the coat(s) on the glass substrate is as follows: Construction Standard En 1096-2 of January 2001, which consists in applying onto a part of the coated surface 9.4 cm long—this part being referred to as the track—a felt 14 mm in diameter, 10 mm thick and with a mass per unit volume of 0.52 g/cm², under a load of 39.22 MPa (400 g/cm²), the felt being subjected to a translation (50 to-and-fro motions over the entire length of the track per minute) combined with a rotation of 6 rpm (1 cycle=1 to-and-fro motion).

After these various treatments, it is generally desired for the glass to maintain good transparency, especially in the case of window glass for motor vehicles (or for other vehicles).

The invention relates to all glass surfaces, more particularly the window glass of motor vehicles, for instance windshields and sliding window glass and more especially side window glass. The surface of the activated glass may have an area of at least 0.25 m² and even at least 0.3 m² and even at least 0.35 m² and even at least 0.4 m².

Thus, the invention also relates to a pane comprising a hydrophobic coating applied to a pane having the activated surface according to the invention, an undercoat containing Si possibly being applied between the glass and the hydrophobic coat. Such a pane provided with a hydrophobic coating may have a resistance in the Opel test at 5000 cycles of at least 80° (water drop angle). The invention also relates to a windshield or sliding window glass of a vehicle, comprising a pane equipped with a hydrophobic coating according to the invention.

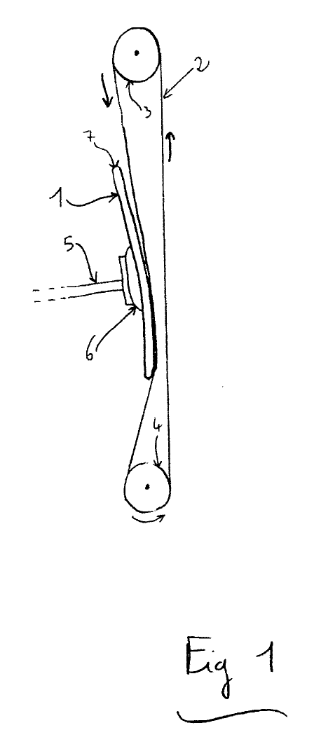

FIG. 1 shows the activation of a ½ face of a toughened motor vehicle side window glass 1 with an abrasive belt 2 closed on itself and traveling vertically by the effect of drive rollers 3 and 4. The belt is about 10 cm wide and has grains of cerium oxide on its surface. The surface to be treated is about 0.4 m². The window glass 1 is applied against the belt 2 by the action of a robot, of which only the end of the arm 5 is shown. This arm holds the window glass 1 by means of suction pads 6 (suction is created in the suction pad by means of a suction system, not shown). The direction of travel of the belt 2 is indicated by arrows. On the window glass, the belt circulates from top to bottom. Water is continuously sprayed onto the surface to be treated and onto the belt. Given the width of the belt (10 cm) relative to the width of the window glass, which is very much wider, the robot performs on the window glass a lateral motion in a direction perpendicular to FIG. 1, while at the same time maintaining contact with the bottom part of the window glass. When the entire lower half-face has been treated, the robot pulls back the window glass so that it is not in contact with the belt, rotates the window glass by 180° so that the top of the window glass becomes the bottom and vice versa, and places it back in contact with the belt. It then treats in the same manner the half-face that had not been treated before the rotation. This thus always avoids the belt coming into contact with an edge in the direction from the exterior of the window glass to the window glass.

### EXAMPLES

The surface of two window glasses is activated by abrasion. One is treated automatically with a belt as described for FIG. 1, the other is a window glass treated manually by an operator using an orbital sander. The two window glasses were curved and their sheared edges were rounded off using a diamond wheel. The window glasses are identical and their main surfaces are each 0.4 m² (a window glass has two parallel main surfaces and a sheared edge). The cerium oxide grains have a particle size of about 2 μm, whether for the automatic polishing or for the manual polishing. The window glasses are rinsed thoroughly with water and then dried.

The automatic polishing leads to a surface tension of 72 mN/m (measured with Plasmatreat®). The manual polishing leads to a surface tension of 65 mN/m, which reflects a less hydrophilic nature than in the case of the automatic polishing (it should be noted that an identical window glass that is not activated but simply degreased with an RBS soap gives a surface tension of between 50 and 60 mN/m).

Identical treatments are applied to the window glasses, first a coat of silica by wiping with TEOS in isopropanol, followed by a hydrophobic coat by wiping with a solution of a fluorosilane of formula CF₃(CF₂)₇CH₂CH₂Si(OCH₂CH₃)₃. This solution was prepared by mixing together 2% by weight of silane and 98% by weight of a solvent. This solvent contained 90% by weight of 2-propanol and 10% by weight of 0.3N HCl in water.

The resistance of the coats is then measured by the Opel test. The angle of contact of a drop of water with the substrate after a certain number of cycles (5000, 7500 and 10000 cycles) is measured. The table below collates the results:

| | 5000 | 7500 | 10 000 |
|---|---|---|---|
| Manual activation | 87 | 86 | 84 |
| Automatic activation | 95 | 95 | 90 |

1-17. (canceled)

18. A pane of curved glass, at least one of the main faces of which is activated.

19. The pane as claimed in claim 18, characterized in that it does not contain any coats.

20. The pane as claimed in claim 18, characterized in that it is transparent.

21. The pane as claimed in claim 18, characterized in that the activated surface has a hydrophilic nature such that its surface tension is at least 62 mN/m at any point.

22. The pane as claimed in claim 18, characterized in that the activated surface has an area of at least 0.25 m².

23. The pane as claimed in claim 22, characterized in that the activated surface has an area of at least 0.3 m².

24. A pane comprising a hydrophobic coating applied to the pane of claim 18.

25. The pane as claimed in claim 24, characterized in that an undercoat containing Si is applied between the glass and the hydrophobic coat.

26. The pane as claimed in claim 18, characterized in that it has a resistance in the Opel test at 5000 cycles of at least 80°.

27. A windshield or sliding window glass of a vehicle, comprising a pane as claimed in claim 24.

28. A process for activating by abrasion a curved glass surface not containing any coats.

29. The activation process as claimed in claim 28, characterized in that the abrasion is performed by rubbing with abrasive grains.

30. The activation process as claimed in claim 29, characterized in that the abrasive grains are made of cerium oxide.

31. The activation process as claimed in claim 28, characterized in that the abrasion is performed with a belt closed on itself and comprising abrasive grains on its surface.

32. The process as claimed in claim 31, characterized in that the pane is applied in automated fashion against the belt by a robot, the activated surface having a surface area of at least 0.25 m², and in that the robot first applies half of the glass against the traveling belt, then returns it to 180° C. to again apply it to the other half against the belt, the belt never coming into contact with an edge in the direction from the exterior of the window glass to the window glass.

33. The activation process as claimed in claim 28, characterized in that the abrasion does not produce any scratches that are visible to the naked eye.

34. A process for preparing a pane of curved glass covered on at least one of its faces with at least one coat, comprising
the activation of the glass surface via the process as claimed in claim 28, and then
the deposition of at least one coat.

35. The process as claimed in claim 34, characterized in that at least one coat is hydrophobic and in contact with the ambient air.

36. The process as claimed in claim 34, characterized in that no acid is used, neither before, nor during, nor after the abrasion treatment.
